(19) United States
(12) Patent Application Publication
(10) Pub. No.: US 2017/0068054 A1
(43) Pub. Date: Mar. 9, 2017

(54) OPTICAL CONNECTOR AND METHOD OF COUPLING OPTICAL CONNECTOR

(71) Applicant: FUJITSU LIMITED, Kawasaki-shi (JP)

(72) Inventor: Mitsuo Suehiro, Kawasaki (JP)

(73) Assignee: FUJITSU LIMITED, Kawasaki-shi (JP)

(21) Appl. No.: 15/245,644

(22) Filed: Aug. 24, 2016

(30) Foreign Application Priority Data
Sep. 7, 2015 (JP) 2015-176059

(51) Int. Cl. G02B 6/38; G02B 6/42; G02B 6/32

(52) U.S. Cl. CPC G02B 6/3882; G02B 6/32; G02B 6/4292; G02B 6/4225; G02B 6/4227

(57) ABSTRACT

An optical connector includes a housing configured to accommodate an optical fiber; two or more pins configured to correspondingly project distal ends of the two or more pins from a surface of the housing on a side of an end surface of the optical fiber and to correspondingly have male threads; and a pin adjuster configured to adjust an amount of projection of the two or more pins by rotating the male threads.

### CROSS-REFERENCE TO RELATED APPLICATION

This application is based upon and claims the benefit of priority of the prior Japanese Patent Application No. 2015-176059, filed on Sep. 7, 2015, the entire contents of which are incorporated herein by reference.

### FIELD

The embodiments discussed herein are related to an optical connector and a method of coupling the optical connector.

### BACKGROUND

Servers, supercomputers, and so forth with a demanded system performance of 100 petabytes per second or more, for example, perform optical communication. An optical connector such as a mechanically transferable (MT) ferrule to which an optical fiber cable is connected is coupled to a lens block that includes an optical element on a substrate, on which a plurality of central processing units (CPUs) are mounted, to achieve large-capacity high-speed transfer.

In the related art, however, displacement such as inclination tends to be caused when coupling the optical connector and the lens block to each other, and desired optical power may not be obtained. In this case, the optical connector is not usable, and a sufficient yield may not be obtained.

Related technologies are disclosed in Japanese Laid-open Patent Publication No. 2012-027327 and Japanese Laid-open Patent Publication No. 2005-345560.

It is desirable to provide an optical connector and a method of coupling the optical connector that improve the yield.

### SUMMARY

According to an aspect of the embodiments, an optical connector includes a housing configured to accommodate an optical fiber; two or more pins configured to correspondingly project distal ends of the two or more pins from a surface of the housing on a side of an end surface of the optical fiber and to correspondingly have male threads; and a pin adjuster configured to adjust an amount of projection of the two or more pins by rotating the male threads.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A is a side view illustrating the structure of an optical connector according to a first embodiment;

FIG. 1B is a front view illustrating the structure of the optical connector according to the first embodiment;

FIG. 1C is a sectional view illustrating the structure of the optical connector according to the first embodiment;

FIG. 2A is a front view illustrating the structure of a lens block;

FIG. 2B is a side view illustrating the structure of the lens block;

FIG. 2C is a sectional view illustrating the structure of the lens block;

FIG. 3 is a flowchart illustrating a method of coupling the optical connector to the lens block;

FIG. 4 is a sectional view illustrating the optical connector and the lens block after being coupled to each other;

FIG. 5A is a sectional view illustrating a state in which the optical connector is fixed to the lens block;

FIG. 5B is a sectional view illustrating a state in which the amount of projection of two pins has been adjusted;

FIG. 5C is a sectional view illustrating a state in which the amount of projection of one pin has been adjusted;

FIG. 6A is a side view illustrating the structure of an optical connector according to a second embodiment;

FIG. 6B is a front view illustrating the structure of the optical connector according to the second embodiment;

FIG. 7A is a side view illustrating the structure of an optical connector according to a third embodiment;

FIG. 7B is a front view illustrating the structure of the optical connector according to the third embodiment;

FIG. 8A illustrates an example of variations in optical power caused along with adjustment of the amount of projection of the pins; and

FIG. 8B illustrates an example of variations in optical power caused along with adjustment of the amount of projection of the pins.

### DESCRIPTION OF EMBODIMENTS

Hereinafter, embodiments will be specifically described with reference to the accompanying drawings.

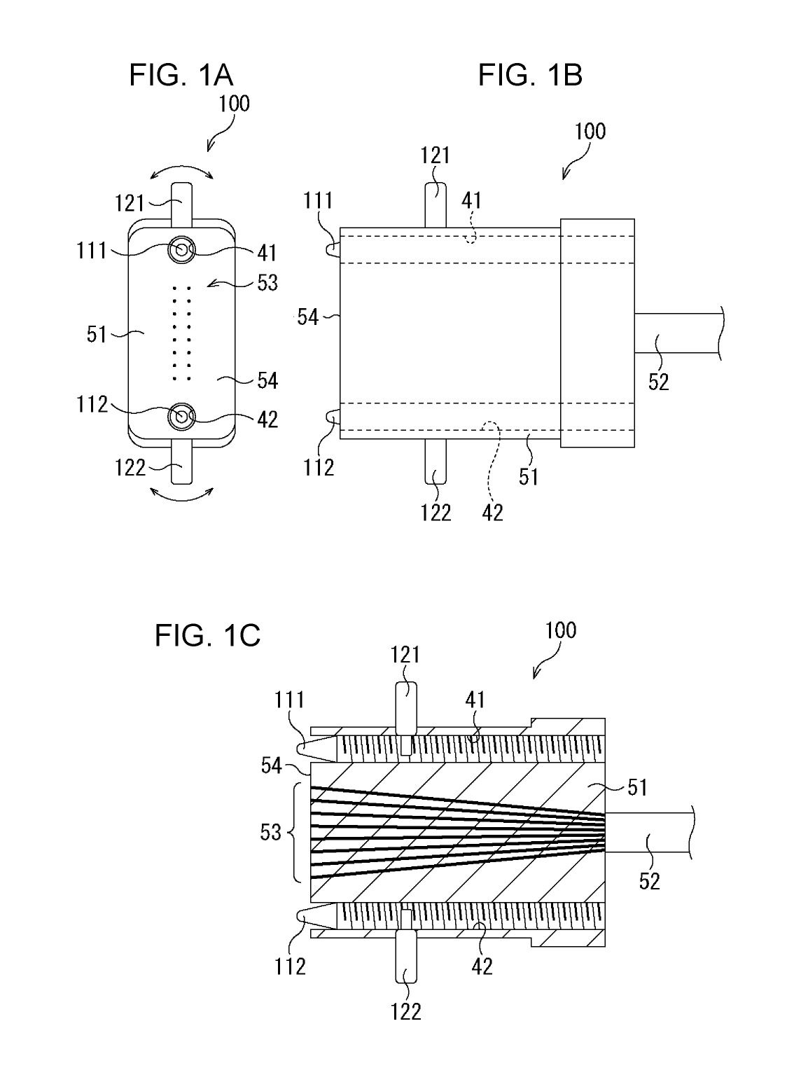

First, a first embodiment will be described. FIGS. 1A, 1B, and 1C are a side view, a front view, and a sectional view, respectively, illustrating the structure of an optical connector according to a first embodiment.

As illustrated in FIGS. 1A through 1C, an optical connector 100 according to the first embodiment includes a housing 51 that accommodates 16 optical fibers 53. Of the 16 optical fibers 53, eight optical fibers 53 are used for transmission (TX) for eight channels, and the remaining eight optical fibers 53 are used for reception (RX) for eight channels. The respective end surfaces of the optical fibers 53 form lines on one surface 54 of the housing 51. The 16 optical fibers 53 are bundled and included in an optical fiber cable 52.

The housing 51 is formed with threaded holes 41 and 42 in which female threads are formed. The threaded hole 41 is formed on the outer side of one end portion of two lines of the optical fibers 53 for transmission and the optical fibers 53 for reception. The threaded hole 42 is formed on the outer side of the other end portion of the two lines of optical fibers 53. A pin 111 on which male threads are formed is inserted into the threaded hole 41. A pin 112 on which male threads are formed is inserted into the threaded hole 42. End portions of the pins 111 and 112 on the surface 54 side are formed in the shape of a cone with a rounded distal end. A lever 121 is fixed to the pin 111. When the lever 121 is tilted, the pin 111 is rotated to move the distal end of the pin 111 by a distance that matches the amount of inclination of the lever 121 and the pitch of the threads, which varies the amount of projection of the distal end of the pin 111 from the surface 54. Similarly, a lever 122 is fixed to the pin 112. When the lever 122 is tilted, the pin 112 is rotated to move the distal end of the pin 112 by a distance that matches the amount of inclination of the lever 122 and the pitch of the threads, which varies the amount of projection of the distal end of the pin 112 from the surface 54.

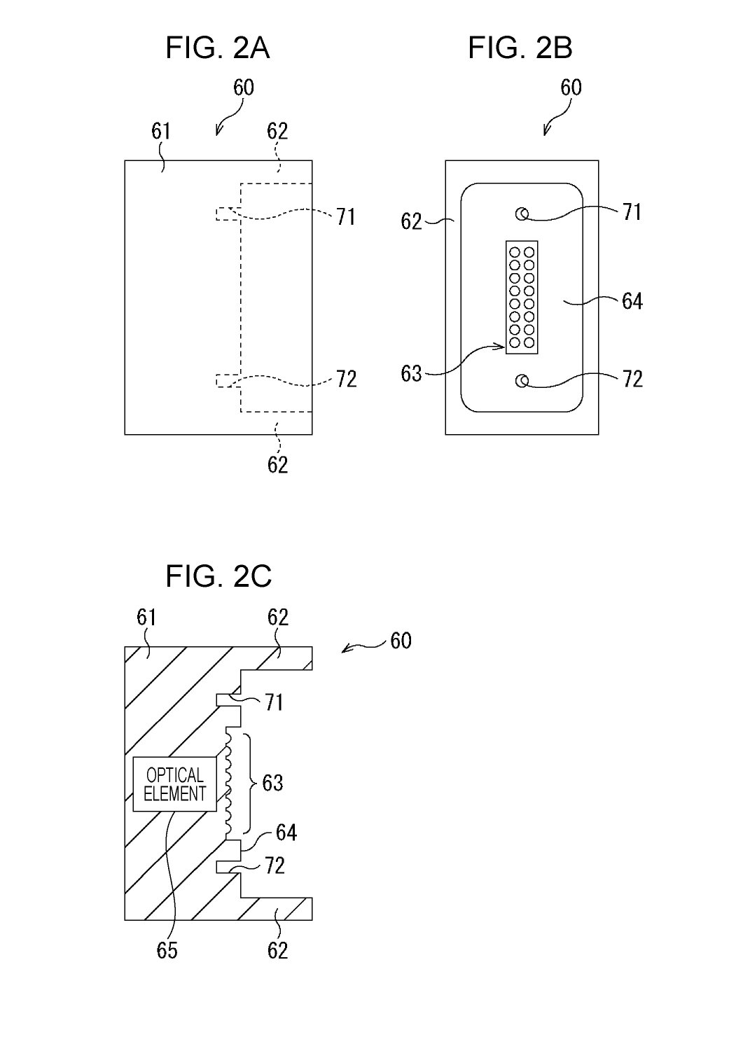

Next, a lens block to which the optical connector 100 is to be coupled will be described. FIGS. 2A, 2B, and 2C are a front view, a side view, and a sectional view, respectively, illustrating the structure of a lens block.

As illustrated in FIG. 2A through 2C, a lens block 60 to which the optical connector 100 is to be coupled includes a housing 61 that accommodates 16 lenses 63. Of the 16 lenses 63, eight lenses 63 are used for transmission (TX) for eight channels, and the remaining eight lenses 63 are used for reception (RX) for eight channels. The lenses 63 form lines on one surface 64 of the housing 61. The housing 61 accommodates an optical element 65 such as a photoelectric conversion element. Light radiated to the lenses 63 is collected at the optical element 65, and light emitted by the optical element 65 is output from the lenses 63. The lens block 60 includes a guide wall 62 that projects from the surface 64 of the housing 61 to guide the optical connector 100.

A guide hole 71 that guides the pin 111 and a guide hole 72 that guides the pin 112 are formed in the surface 64 of the housing 61. The guide hole 71 is formed on the outer side of one end portion of two lines of the lenses 63 for transmission and the lenses 63 for reception. The guide hole 72 is formed on the outer side of the other end portion of the two lines of lenses 63.

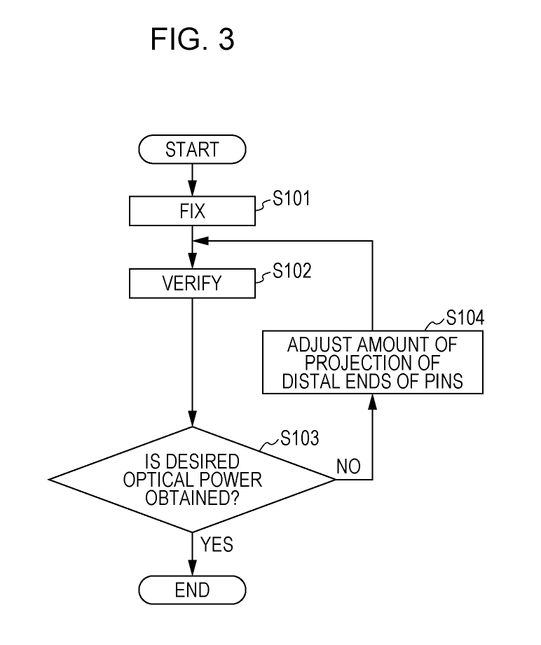

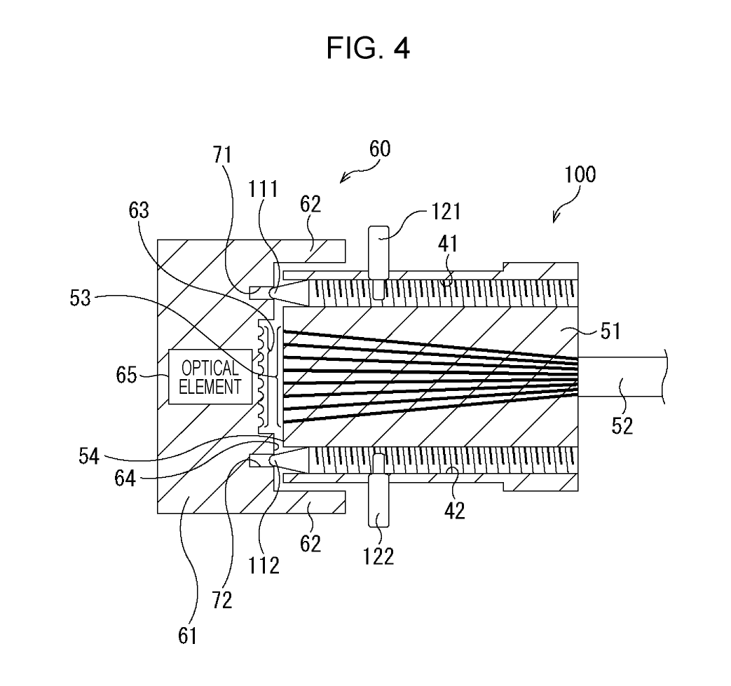

Next, a method of coupling the optical connector 100 to the lens block 60 will be described. FIG. 3 is a flowchart illustrating a method of coupling the optical connector to the lens block. FIG. 4 is a sectional view illustrating the optical connector and the lens block after being coupled to each other.

First, the optical connector 100 is fixed to the lens block 60 using a clip (not illustrated) by inserting the optical connector 100 inside the guide wall 62 and causing the respective distal ends of the pins 111 and 112 to abut against the inside of the guide holes 71 and 72, respectively (step S101). Then, it is verified whether or not desired optical power is obtained (step S102). If desired optical power is obtained (step S103), a coupling operation is finished. In the case where desired optical power is not obtained (step S103), on the other hand, the amount of projection of one or both of the pins 111 and 112 from the surface 54 is adjusted by operating one or both of the levers 121 and 122 (step S104). Verification (step S102) and adjustment (step S104) are repeated until desired optical power is obtained.

By coupling the optical connector 100 to the lens block 60 in this way, desired optical power may be obtained through appropriate adjustment even if desired optical power is not obtained because of displacement such as inclination in the early stage of fixation. Thus, the yield may be improved.

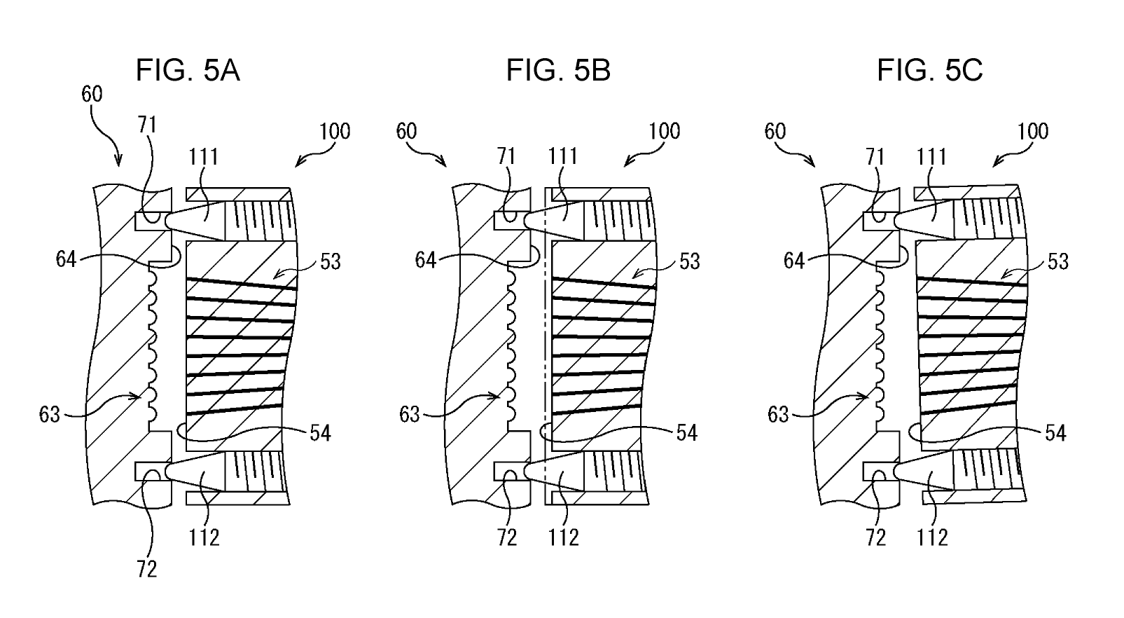

An example of the method of adjusting the amount of projection of one or both of the pins 111 and 112 from the surface 54 will be described. It is assumed, for example, that the state illustrated in FIG. 5A has been established when the optical connector 100 is fixed to the lens block 60 using a clip. In the case where the result of the verification performed in this state indicates that the optical fibers 53 are too close to the lenses 63, the amount of projection of the pins 111 and 112 is increased. As a result, as illustrated in FIG. 5B, the distance of the optical fibers 53 from the lenses 63 is increased. Meanwhile, in the case where the result of the verification performed in the state illustrated in FIG. 5A indicates that desired optical power is obtained in channels close to the pin 111 but that the optical fibers 53 are too close to the lenses 63 in channels close to the pin 112, only the amount of projection of the pin 112 is increased. As a result, as illustrated in FIG. 5C, the distance of the optical fibers 53 from the lenses 63 is increased more significantly for channels closer to the pin 112. It may be considered that the focal length is adjusted in the example illustrated in FIG. 5B. It may be considered that the focal length and the angle are adjusted in the example illustrated in FIG. 5C.

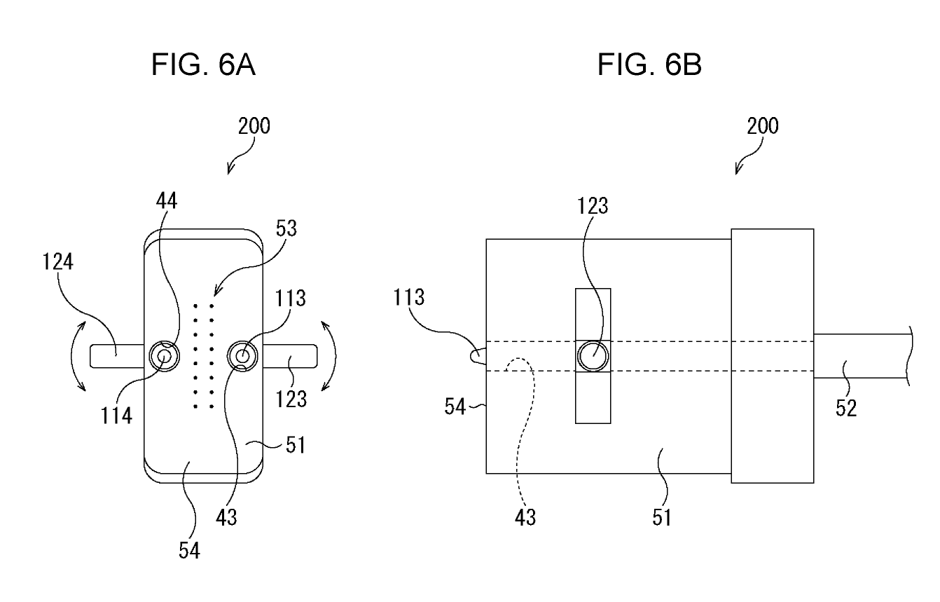

Next, a second embodiment will be described. FIGS. 6A and 6B are a side view and a front view, respectively, illustrating the structure of an optical connector according to a second embodiment.

As illustrated in FIG. 6A, an optical connector 200 according to a second embodiment includes a housing 51 that accommodates 16 optical fibers 53, as in the first embodiment. The housing 51 is formed with threaded holes 43 and 44 in which female threads are formed, in place of the threaded holes 41 and 42. The threaded hole 43 is formed at a side of a line of optical fibers 53 for transmission. The threaded hole 44 is formed at a side of a line of optical fibers 53 for reception. A pin 113 on which male threads are formed is inserted into the threaded hole 43. A pin 114 on which male threads are formed is inserted into the threaded hole 44. End portions of the pins 113 and 114 on the surface 54 side are formed in the shape of a cone with a rounded distal end. A lever 123 is fixed to the pin 113. When the lever 123 is tilted, the pin 113 is rotated to move the distal end of the pin 113 by a distance that matches the amount of inclination of the lever 123 and the pitch of the threads, which varies the amount of projection of the distal end of the pin 113 from the surface 54. Similarly, a lever 124 is fixed to the pin 114. When the lever 124 is tilted, the pin 114 is rotated to move the distal end of the pin 114 by a distance that matches the amount of inclination of the lever 124 and the pitch of the threads, which varies the amount of projection of the distal end of the pin 114 from the surface 54. The optical connector 200 is otherwise the same as the optical connector 100.

As with the lens block 60, a lens block to which the optical connector 200 is to be coupled includes a housing that accommodates 16 lenses. A guide hole that guides the pin 113 and a guide hole that guides the pin 114 are formed in the housing, in place of the guide holes 71 and 72. The guide hole which guides the pin 113 is formed at a side of the lenses 63 for transmission. The guide hole which guides the pin 114 is formed at a side of the lenses 63 for reception. The lens block is otherwise the same as the lens block 60.

Also in the second embodiment, as in the first embodiment, desired optical power may be obtained through appropriate adjustment even if desired optical power is not obtained because of displacement such as inclination in the early stage of fixation. Thus, the yield may be improved. In the first embodiment, the focal length or the like may be adjusted among the plurality of channels. In the second embodiment, the focal length or the like may be adjusted between the line of lenses 63 for transmission and the line of lenses 63 for reception.

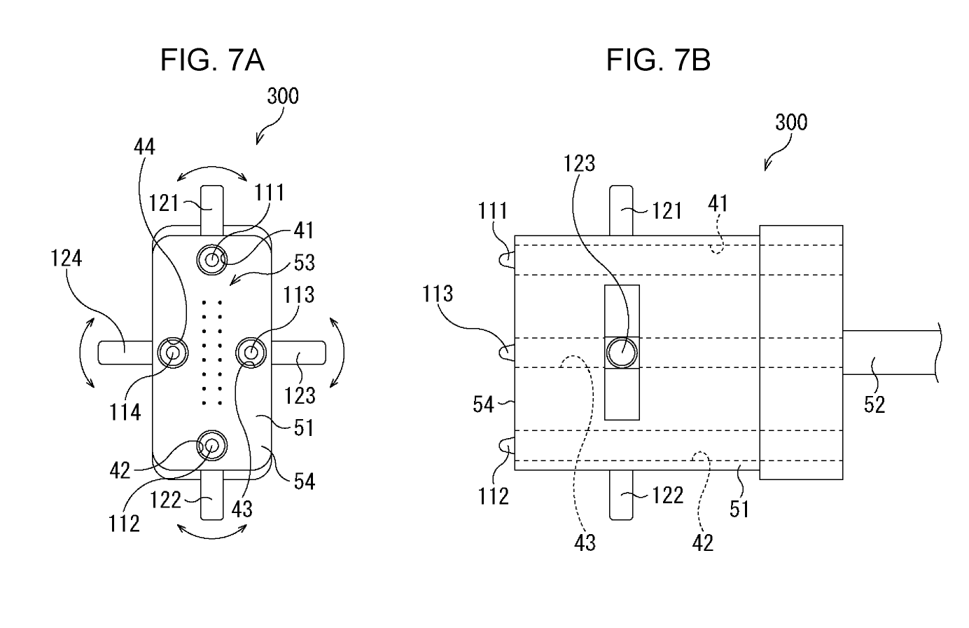

Next, a third embodiment will be described. FIGS. 7A and 7B are a side view and a front view, respectively, illustrating the structure of an optical connector according to a third embodiment.

As illustrated in FIG. 7A, an optical connector 300 according to a third embodiment includes a housing 51 that accommodates 16 optical fibers 53, as in the first embodiment. The housing 51 is formed with threaded holes 43 and 44, as in the second embodiment, in addition to the threaded holes 41 and 42. The pin 111 is inserted into the threaded hole 41. The pin 112 is inserted into the threaded hole 42. The pin 113 is inserted into the threaded hole 43. The pin 114 is inserted into the threaded hole 44. The optical connector 300 is otherwise the same as the optical connector 100.

As with the lens block 60, a lens block to which the optical connector 300 is to be coupled includes a housing that accommodates 16 lenses. A guide hole that guides the pin 113 and a guide hole that guides the pin 114 are formed in the housing, as in the second embodiment, in addition to the guide holes 71 and 72. The lens block is otherwise the same as the lens block 60.

Also in the third embodiment, as in the first and second embodiments, desired optical power may be obtained through appropriate adjustment even if desired optical power is not obtained because of displacement such as inclination in the early stage of fixation. Thus, the yield may be improved. In the third embodiment, the focal length or the like may be adjusted among the plurality of channels, and the focal length or the like may be adjusted between the line of lenses 63 for transmission and the line of lenses 63 for reception as well.

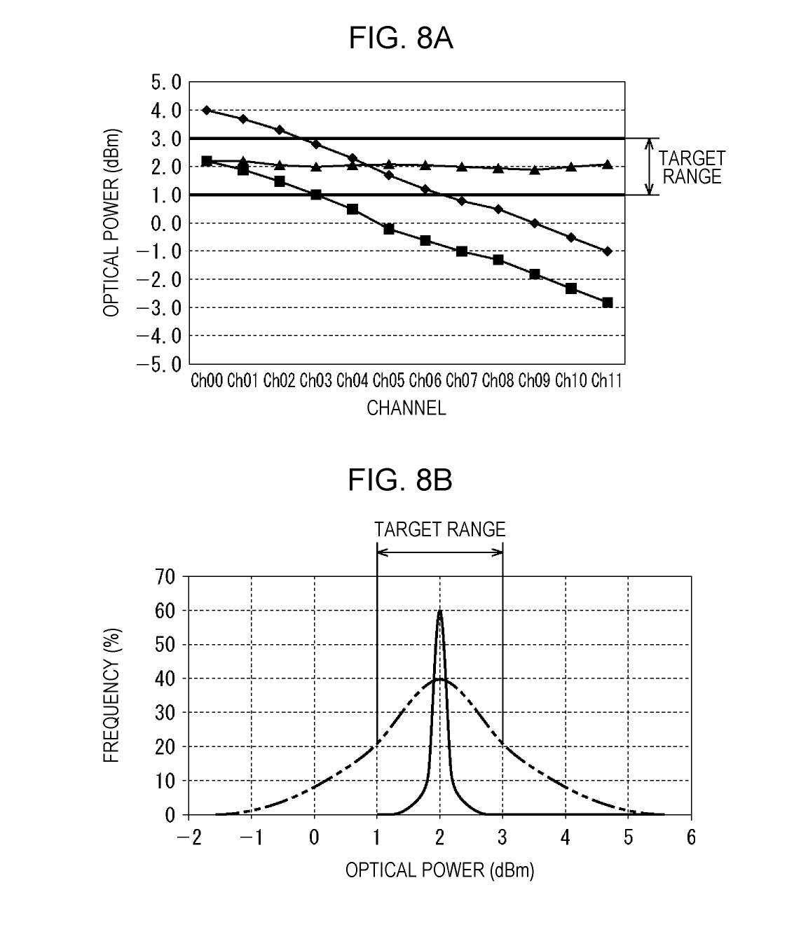

Next, an example of variations in optical power caused along with adjustment of the amount of projection of the pins will be described. FIGS. 8A and 8B illustrate an example of variations in optical power caused along with adjustment of the amount of projection of the pins. In the example, it is assumed that transfer is performed in 12 channels.

It is assumed that the distribution of optical power as indicated by diamond marks in FIG. 8A has been obtained at first. In this state, optical power in channels Ch00 to Ch03 is too high, and optical power in channels Ch07 to Ch11 is too low. In this state, the amount of projection of two pins provided on the outer side of end portions of lines of optical fibers, such as the pins 111 and 112, is increased such that optical power in the channel Ch00 is about the median value (2.0 dBm) of the target range. As a result, optical power is reduced as a whole, and the distribution of optical power generally as indicated by square marks in FIG. 8A is obtained. In this state, the amount of projection of one pin provided on the channel Ch11 side is reduced such that optical power in the channel Ch11 is about the median value (2.0 dBm) of the target range. As a result, optical power is increased more significantly on the channel Ch11 side, and the distribution of optical power generally as indicated by triangular marks in FIG. 8A is obtained.

Such optical connectors may be used in servers, high-end computers for use for high-performance computing (HPC) or the like, devices that use a printed board on which an optical component with a vertical cavity surface emitting laser (VCSEL)/photo diode (PD) optical element is mounted, and so forth. The optical connectors may be mechanically transferable (MT) ferrules.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical connector, comprising:
a housing configured to accommodate an optical fiber;
two or more pins configured to correspondingly project distal ends of the two or more pins from a surface of the housing on a side of an end surface of the optical fiber and to correspondingly include male threads; and
a pin adjuster configured to adjust an amount of projection of the two or more pins by rotating the male threads.

2. The optical connector according to claim 1,
wherein the pin adjuster is configured to include levers correspondingly fixed to the two or more pins.

3. The optical connector according to claim 2,
wherein the levers are opposite sides one another via the housing.

4. A method of coupling an optical connector that includes a housing configured to accommodate an optical fiber, two or more pins configured to correspondingly project distal ends of the two or more pins from a surface of the housing on a side of an end surface of the optical fiber and to correspondingly have male threads, and a pin adjuster configured to adjust an amount of projection of the two or more pins by rotating the male threads, the method comprising:
coupling the optical connector to a lens block that includes a laser diode and/or a photo diode;
verifying optical power at the laser diode and/or the photo diode; and
adjusting the amount of projection of two or more pins using the pin adjuster in accordance with a result of the verifying.
